(19) United States
(12) Patent Application Publication
(10) Pub. No.: US 2005/0160188 A1
(43) Pub. Date: Jul. 21, 2005

(54) Method and apparatus to manage memory access requests

(76) Inventors: Zohar Bogin, Folsom, CA (US); Arthur D. Hunter JR., Cameron Park, CA (US); Krishnamurthy B. Venkataramana, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/762,037

(22) Filed: Jan. 20, 2004

(51) Int. Cl. G06F 3/00

(52) U.S. Cl. 710/1

(57) ABSTRACT

A method and apparatus for managing memory access requests have been disclosed. One embodiment of the method includes dynamically modifying attributes of each of a number of requests to access one or more memory devices and arbitrating among the requests to select a request to send to the memory devices in a time slot based on the attributes. Other embodiments are described and claimed.

### FIELD OF INVENTION

The present invention relates generally to computer systems, and more particularly, to managing memory access requests in a computer system.

### BACKGROUND

In an exemplary computer system, peripheral devices may assert requests to access data stored on memory devices in the system. For example, a speaker may receive audio data from the memory devices. To control the peripheral devices, the computer system may include an input/output controller coupled to the peripheral devices. The input/output controller may include a number of controllers (e.g., an audio controller), each responsible for a certain type of peripheral devices (e.g., audio devices). The controllers may assert memory access requests on behalf of the corresponding peripheral devices. The input/output controller arbitrates among the memory access requests and sends the requests to the memory devices via an interconnect (e.g., Peripheral Component Interconnect Express bus).

According to the protocol of Peripheral Component Interconnect (PCI) Express, a period is divided into a number of time slots. Each controller within the input/output controller is allotted a number of time slots. One request is sent in each allotted time slot. However, since the requests may come in different lengths, the excess bandwidth in a time slot is wasted if the request does not use up the entire time slot.

Furthermore, the requests may have different levels of latency sensitivity. However, the existing controllers do not provide a mechanism to distinguish requests at different latency sensitivity levels and to manage the requests in response to their latency sensitivity. Therefore, requests with high level of latency sensitivity may not be sent to the memory devices in time, and consequently, glitches may appear in the data stream.

### BRIEF DESCRIPTION OF THE DRAWINGS

The present invention will be understood more fully from the detailed description that follows and from the accompanying drawings, which however, should not be taken to limit the appended claims to the specific embodiments shown, but are for explanation and understanding only.

FIG. 1 shows a flow diagram of one embodiment of a process for managing memory access requests.

FIG. 2 illustrates one embodiment of an input/output controller.

FIG. 3A illustrates one embodiment of circuitry to determine data request length.

FIG. 3B illustrates one embodiment of circuitry to determine buffer descriptor request length.

FIG. 3C illustrates a state diagram of one embodiment of a priority state machine.

FIG. 3D illustrates one embodiment of an arbiter.

FIG. 4 illustrates an exemplary embodiment of a computer system.

### DETAILED DESCRIPTION

In the following description, a method and apparatus to manage memory access requests have been disclosed. Numerous specific details are set forth below. However, it is understood that embodiments of the invention may be practiced without these specific details. In other instances, well-known circuits, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

Some portions of the following detailed description are presented in terms of symbolic representations of operations on data bits within a computer memory. These descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relates to apparatus for performing the operations described herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The operations and displays presented herein are not inherently related to any particular computer or other apparatus. Various general-purpose systems may be used with programs in accordance with the teachings herein, or it may prove convenient to construct more specialized apparatus to perform the operations described. The required structure for a variety of these systems will appear from the description below. In addition, embodiments of the present invention may not be described with reference to any particular programming language. It will be appreciated that a variety of programming languages may be used to implement the teachings of the invention as described herein.

A “machine-readable medium,” as the term is used in this document, includes any mechanism for storing or transmitting information in a form readable by a machine (e.g., a computer). For example, a machine-readable medium includes ROM; RAM; magnetic disk storage media; optical storage media; flash memory devices; electrical, optical, acoustical or other form of propagated signals (e.g., carrier waves, infrared signals, digital signals, etc.); etc.

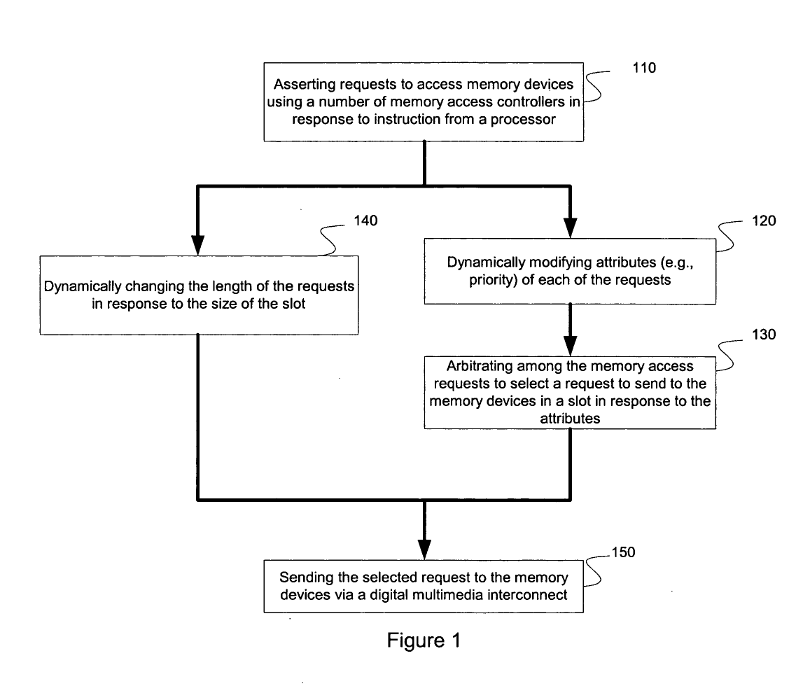

FIG. 1 illustrates a flow diagram of one embodiment of a process for managing memory access requests. The process is performed by processing logic that may comprise hardware (e.g., circuitry, dedicated logic, etc.), software (such as is run on a general purpose computer system or a dedicated machine), or a combination of both.

Processing logic asserts a number of requests to access memory devices using a number of memory access controllers (processing block 110). The requests may be asserted in response to instruction from a central processing unit in a computer system. The requests may include read and/or write data requests and buffer descriptor requests. The memory access controllers may include direct memory access (DMA) controllers, such as data DMA controllers (both inbound and outbound) and buffer descriptor (BD) DMA controllers. In one embodiment, a data DMA controller is responsible for accessing data in the memory devices, while a BD DMA controller is responsible for accessing BDs in a BD list. Each BD includes an address and a size of a piece of data in the memory devices. In one embodiment, each data DMA controller has a corresponding BD DMA controller.

In one embodiment, the DMA controllers are part of an audio controller within an input/output controller in a computer system. The audio controller may control data transfer between one or more audio coder-decoders and the memory devices. Such audio coder-decoders may be part of a headset, a speaker, a telephone, etc.

Referring back to FIG. 1, processing logic dynamically modifies attributes of each of the requests (processing block 120). For example, processing logic dynamically modifies the priorities of the requests in response to the latency sensitivity of the requests. The latency sensitivity is related to how fast data transfer for a request has to be. A request requires faster data transfer when the latency sensitivity of the request is higher.

In one embodiment, processing logic classifies latency sensitivity of requests into two levels, namely, high and low. Processing logic may cause a DMA controller to assert a request having latency sensitivity at the low level when the data that can be fetched or evicted from a buffer of the DMA controller reaches a first threshold. Furthermore, processing logic may cause the DMA controller to increase the latency sensitivity of the request to the high level when the amount of room available in the buffer reaches a second threshold. The second threshold is not dependent on the first threshold.

Referring to FIG. 1, processing logic arbitrates among the requests to select a request to send to the memory devices in a time slot in response to the attributes (processing block 130). Processing logic may arbitrate on each clock cycle to select the request with the highest latency sensitivity. Processing logic may adopt various arbitration schemes, such as First Come First Serve (FCFS), Weighted Round Robin (WRR), etc. Detail of various arbitration schemes is discussed below. Moreover, the time slot may be allotted by an interconnect controller, such as a digital multimedia interconnect (DMI) controller, interfacing with an interconnect (e.g., DMI) that couples the audio controller to the memory devices.

Besides prioritizing the requests, processing logic may change the length of the requests dynamically in response to the size of the time slot (processing block 140). For example, processing logic may increase the length of the request up to the size of the time slot when the amount of available data to be fetched or evicted increases.

In one embodiment, processing logic determines the length of a request in response to various factors. For example, the factors may include the space available in the buffer of the DMA controller and the remaining bytes of data to be read/written from/to the corresponding BD. Furthermore, processing logic may not allow the data request length to exceed the upper limit of the slot size of the interconnect via which the request is sent. By dynamically changing the request length, processing logic may combine smaller requests into a bigger request, when possible, to better utilize each time slot allotted to the audio controller. Consequently, processing logic may increase the efficiency of the audio controller.

Finally, processing logic sends the selected request to the memory devices (processing block 150). As mentioned above, processing logic may send the request via the DMI to the memory devices. In one embodiment, processing logic follows the Peripheral Component Interconnect (PCI) Express protocol, which supports isochronous data transfer. The ability to dynamically change request length and to dynamically prioritize requests according to the latency sensitivity of the requests allows isochronous data transfer to receive the allocated bandwidth over a relevant period of time without starving non-isochronous traffic.

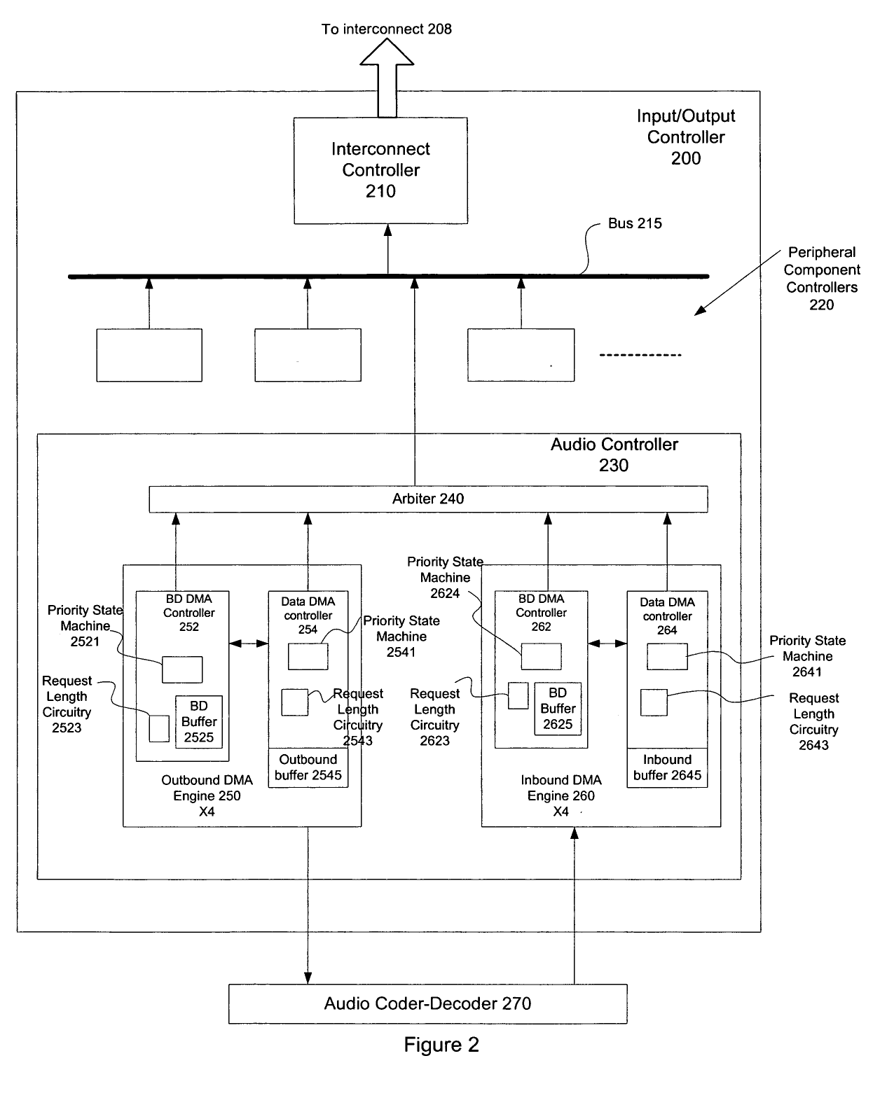

FIG. 2 illustrates one embodiment of an input/output controller. The input/output controller 200 includes an interconnect controller 210 (e.g., a DMI controller), a number of peripheral device controllers 220 and 230, and a bus 215 coupling the peripheral device controllers 220 and 230 to the interconnect controller 210. The interconnect controller 210 drives an interconnect 208 (e.g., a DMI). Memory devices are coupled to the input/output controller 200 via the interconnect 208. The interconnect controller 210 and the bus 215 may also be collectively referred to as a “back bone” of the input/output controller 200. The peripheral device controllers 220 and 230 may include a Universal Serial Bus (USB) controller, an audio controller 230, etc.

In one embodiment, the audio controller 230 includes an arbiter 240, a number of outbound DMA engines 250, and a number of inbound DMA engines 260. For example, the audio controller 230 may have four outbound DMA engines and four inbound DMA engines. The inbound and outbound DMA engines 250 and 260 drive one or more audio coder-decoders 270 in one or more peripheral devices, such as, for example, speakers, telephones, headsets, etc. Note that only one outbound DMA engine 250 and one inbound DMA engine 260 are shown in FIG. 2 to avoid obscuring the embodiment of the invention.

Each outbound DMA engine 250 may include a BD DMA controller 252 and a data DMA controller 254. The BD DMA controller 252 may include a priority state machine 2521, circuitry 2523 to determine BD request length, and a BD buffer 2525. The BD buffer 2525 may include a First In First Out (FIFO) buffer. Likewise, the data DMA controller 254 may include a priority state machine 2541, circuitry 2543 to determine data request length, and an outbound data buffer 2545. The outbound data buffer 2545 may include a FIFO buffer.

Each inbound DMA engine 260 may include a BD DMA controller 262 and a data DMA controller 264. The BD DMA controller 262 may include a priority state machine 2621, circuitry 2623 to determine BD request length, and a BD buffer 2625. The BD buffer 2625 may include a First In First Out (FIFO) buffer. In one embodiment, the data DMA controller 264 includes a priority state machine 2641, circuitry 2643 to determine data request length, and an outbound data buffer 2645. The outbound data buffer 2645 may include a FIFO buffer.

Each of the BD DMA controllers 252 and 262, as well as the data DMA controllers 254 and 264, asserts a request to access memory devices and sends the request to the arbiter 240. The arbiter 240 selects a request out of these requests in response to the latency sensitivity of these requests and presents the request to the back bone of the input/output controller 230. The interconnect controller 210 allots a time slot to each of the controllers 220 and 230 periodically. When the audio controller 230 is allotted a time slot, the selected request is sent in the allotted time slot via the interconnect 208.

In order to increase the efficiency of the audio controller 230, each of the BD and data DMA controllers 252, 262, 254, and 264 includes a priority state machine (e.g., the priority state machines 2521, 2541, 2621, and 2641) to dynamically prioritize the requests of the DMA controllers in response to the latency sensitivity of the requests. In one embodiment, the latency sensitivity is divided into two levels, namely, high and low. The priority state machine may change the level of the latency sensitivity in response to the space available in the buffer of the corresponding DMA controller. More detail of the priority state machine is discussed below.

Furthermore, each of the DMA controllers 252, 262, 254, and 264 includes circuitry to determine the request length in response to the size of the time slot allotted to the audio controller 230. For example, a number of smaller requests may be combined into a single request to be sent in a single time slot. Therefore, the DMA controllers 252, 262, 254, and 264 can better utilize the time slot allotted to send request by dynamically changing the request length.

Although the technique disclosed is illustrated above with reference to the audio controller 230, one should appreciate that the technique may be applicable to other controllers in the computer system to manage memory access requests.

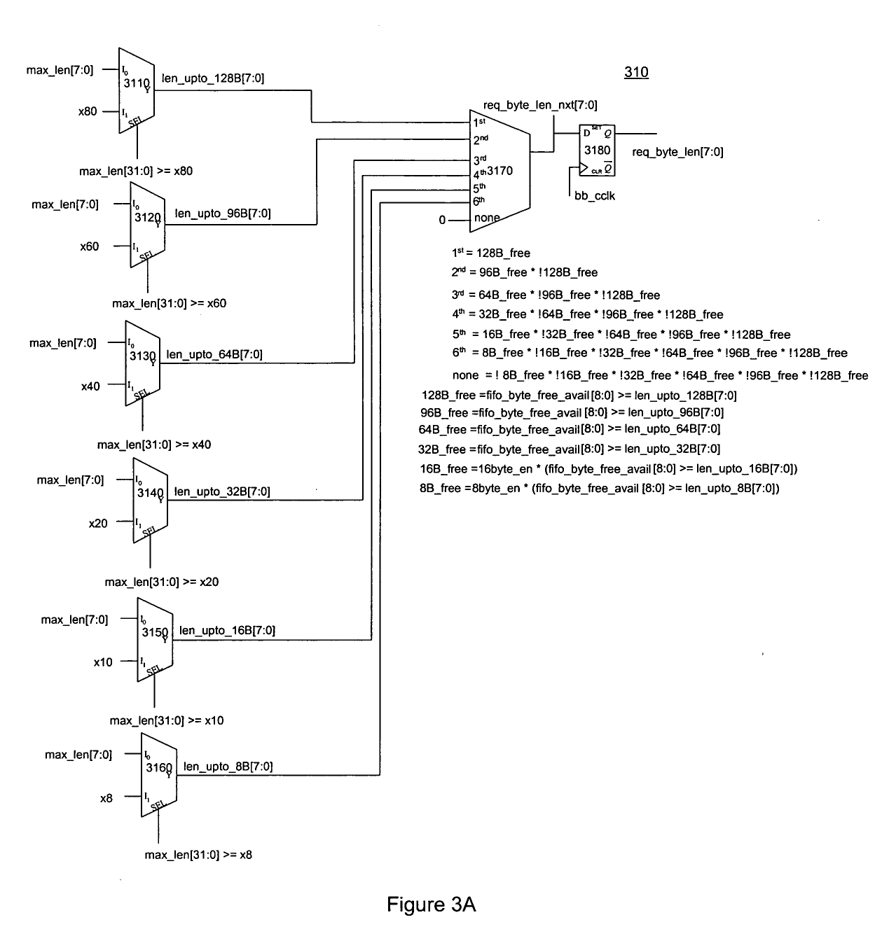

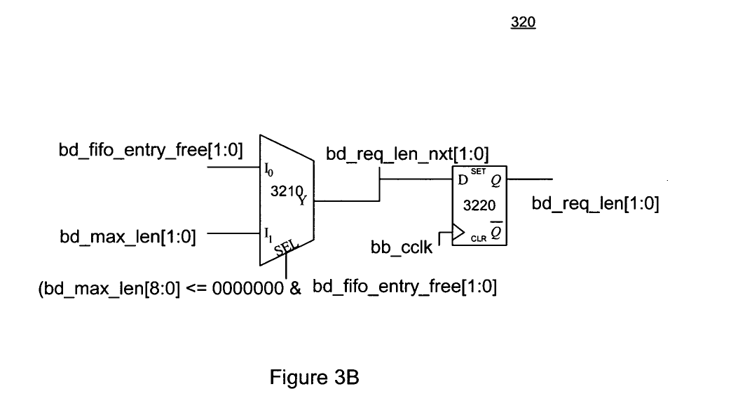

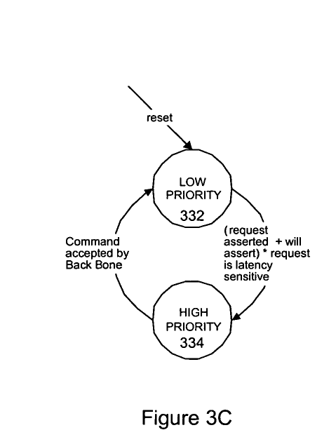

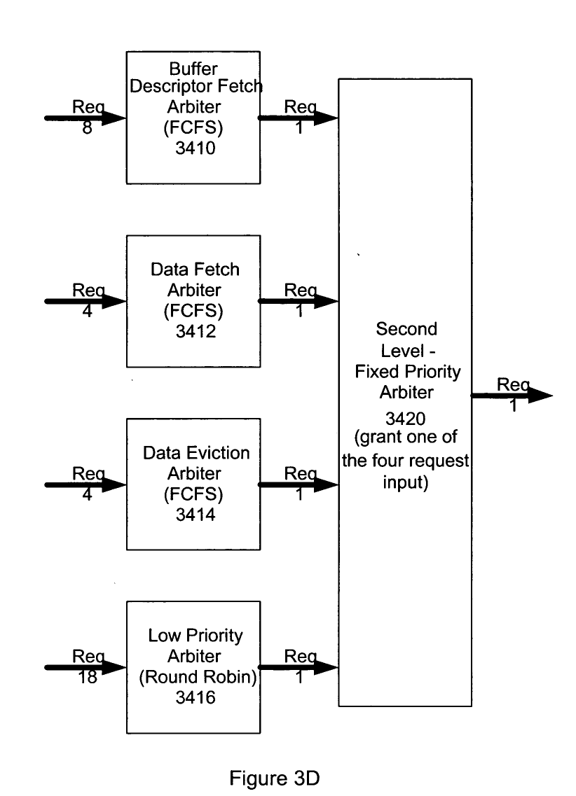

FIG. 3A illustrates one embodiment of circuitry to determine data request length in a data DMA controller. The circuitry 310 includes a number of multiplexers 3110-3170 and a flip-flop 3180. The output of each of the multiplexers 3110-3160 is input to the multiplexer 3170. The output of the multiplexer 3170 is input to the flip-flop 3180. The flip-flop 3180 may include a delay flip-flop (D flip-flop). The output of the flip-flop 3180 is the data request length determined, req_byte_len[7:0]. Control signals (e.g., max_len[31:0]>=x80) are input to the multiplexers 3110-3160.

In one embodiment, three variables are defined to determine a data request length, namely, REQ_LEN, REM_DESC_LEN, and FIFO_SPACE. REQ_LEN is the request length. REM_DESC_LEN is the number of the remaining bytes of data to be read/written from/to the corresponding buffer. FIFO_SPACE is the buffer space available to trigger a read/write request.

REQ_LEN may be determined according to three rules. First, the request length cannot exceed the maximum slot size of the interconnect via which the request is sent. For example, an interconnect adopting PCI Express protocol allows a maximum slot size of 128 bytes, and thus, the request length in a PCI Express system cannot exceed 128 bytes. Second, REQ_LEN cannot exceed REM_DESC_LEN. Third, REQ_LEN is set to be substantially equal to FIFO_SPACE, subject to the two rules above. In one embodiment, if FIFO_SPACE is 8 bytes and 8 byte mode is enabled, then REQ_LEN is 8 bytes. If FIFO_SPACE is 16 bytes and 16 byte mode is enabled, then REQ_LEN is 16 bytes. If FIFO_SPACE is 32 bytes, then REQ_LEN is 32 bytes. If FIFO_SPACE is 64 bytes, then REQ_LEN is 64 bytes. If FIFO_SPACE is 96 bytes, then REQ_LEN is 96 bytes. If FIFO_SPACE is 128 bytes, then REQ_LEN is 128 bytes. The above rules may be represented by the formulae shown in FIG. 3A. However, one should appreciate that these specific rules and figures are described merely for the purpose of illustration. Other embodiments may adopt different rules or figures to implement the concept disclosed.

FIG. 3B illustrates one embodiment of circuitry to determine BD request length in a BD DMA controller. The circuitry 320 includes a multiplexer 3210 and a flip-flop 3220. The output of the multiplexer 3210 is coupled to the flip-flop 3220, which latches the output of the multiplexer 3210. The output of the flip-flop 3220 is the BD request length determined, bd_req_len[1:0]. In one embodiment, each BD in a BD list has 16 bytes. Therefore, the length of a BD read may be multiples of 16 bytes (e.g., 16 bytes, 32 bytes, 48 bytes, etc.), depending on the buffer size of the BD DMA controller.

In one embodiment, three variables are defined to determine the request length of BD request, namely, REQ_LEN, REM_BD_LEN, and FIFO_SPACE. REQ_LEN is the BD request length. REM_BD_LEN is the number of remaining BDs to be read from the corresponding BD list. REQ_LEN may be determined according to three rules. First, REQ_LEN may not exceed the maximum slot size of the interconnect via which the request is sent. For example, an interconnect adopting PCI Express protocol allows a maximum slot size of 128 bytes, and thus, the request length in a PCI Express system cannot exceed 128 bytes. Second, REQ_LEN may not exceed REM_BD_LEN. Third, REQ_LEN is set to be substantially equal to FIFO_SPACE, subject to the above two rules. Specifically, suppose the length of each BD is 16 bytes and if FIFO_SPACE is 1 BD long, then REQ_LEN is 1 BD, i.e., 16 bytes. Likewise, if FIFO_SPACE is 2 BDs long, then REQ_LEN is 32 bytes; and if FIFO_SPACE is 3 BDs long, then REQ_LEN is 48 bytes. However, one should appreciate that these specific rules and figures are described merely for the purpose of illustration. Other embodiments may adopt different rules or figures to implement the concept disclosed.

FIG. 3C illustrates the state diagram of one embodiment of a priority state machine in a DMA controller (e.g., a BD DMA controller or a data DMA controller). Referring to FIG. 3C, the state machine has two states, namely, low priority 332 and high priority 334. In one embodiment, when the state machine is reset, the state machine goes into the low priority state 332. The state machine may enter the high priority state 334 when a request is asserted, or going to be asserted in the next clock cycle, by the DMA controller and the request has become latency sensitive. For example, a BD request becomes latency sensitive when the BD buffer in the BD DMA controller is empty. A read data request may become latency sensitive when the data in the data buffer of the data DMA controller is below a predetermined threshold, such as one frame of data. A write data request may become latency sensitive when the available space in the data buffer of the data DMA controller falls below a predetermined threshold, such as one frame of data.

In one embodiment, the state machine goes from the low priority state 332 to the high priority state 334 when the request is accepted by the interconnect controller 210 of the input/output controller 200 (referring to FIG. 2).

FIG. 3D illustrates one embodiment of an arbiter in an audio controller (e.g., the arbiter 240 in the audio controller 230 in FIG. 2). The arbiter 340 includes two levels. The first level has four arbiters 3410-3416 and the second level has a fixed priority arbiter 3420. The first level arbiters may include three First Come First Served (FCFS) arbiters 3410-3416 and a round robin arbiter 3416 to arbitrate among requests having substantially the same latency priority. The second level arbiter 3420 arbitrates among the outputs of the first level arbiters 3410-3416.

In one embodiment, the BD fetch arbiter 3410 arbitrates among the BD requests from the BD DMA controllers (e.g., BD DMA controllers 252 and 262 in FIG. 2). Each BD DMA controller sends a request to the BD fetch arbiter 3410. For example, the arbiter 3410 receives eight requests if the audio controller has eight BD DMA controllers.

Referring to FIG. 3D, the arbiter 3412 arbitrates among the read data requests (also known as data fetch requests) of high latency sensitivity from the data DMA controllers (e.g., the data DMA controller 254 in FIG. 2). For example, in an audio controller having four read data DMA controllers, there may be four read data requests of high latency sensitivity input to the arbiter 3412. Likewise, the arbiter 3414 arbitrates among the data write requests (also known as data evict requests) of high latency sensitivity from the data DMA controllers (e.g., the data DMA controller 264 in FIG. 2). In one embodiment, both read and write data requests of low latency sensitivity are arbitrated by the round robin arbitrator 3416.

Each of the FCFS arbiters 3410-3414 may be implemented using a queue to hold the order of the assertion of the high latency requests. The round robin arbiter 3416 may adopt a weighted round robin (WRR) scheme that uses fixed priority arbitration with request masking on selected DMA controllers. For example, a DMA controller may be selected when the DMA controller asserts a request, the request asserted is not masked, no high latency request is active, and no other higher priority non-masked low latency sensitive DMA controller is requesting.

In one embodiment, the first level arbiters 3410-3416 arbitrate between the DMA controllers in every clock cycle (e.g., clock cycle X) and select a request from one of the DMA controllers in the following clock cycle (e.g., clock cycle X+1). The second level arbiter 3420 selects a request in clock cycle (X+1). In addition, the attributes of the selected request may be sent in clock cycle (X+1) to the interconnect controller 210 (referring to FIG. 2). Therefore, the arbiter 340 may ensure a request is pending and ready to go substantially all the time to prevent wasting time slots allotted to the audio controller.

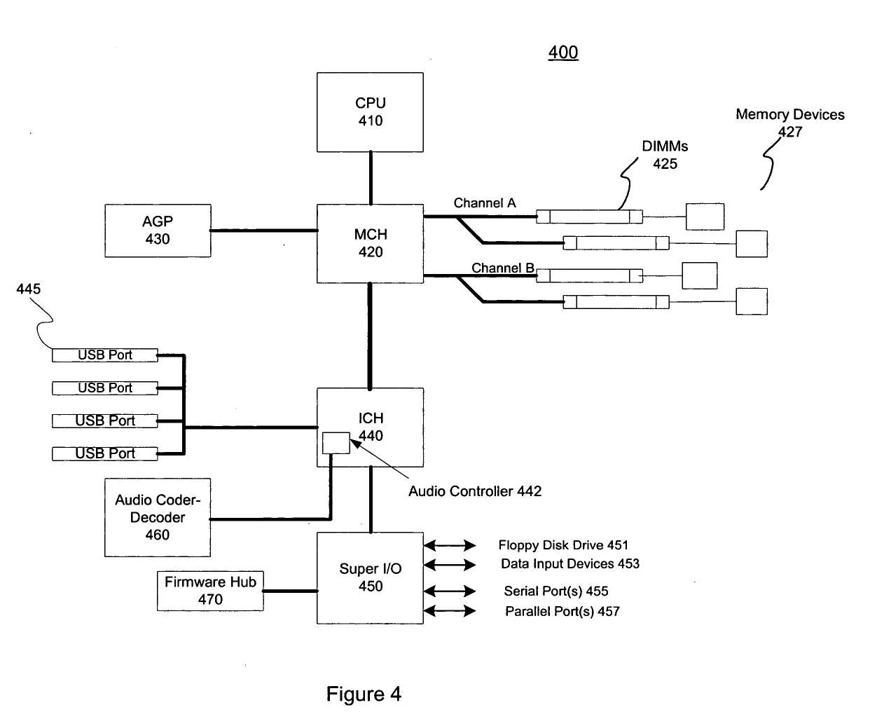

FIG. 4 shows an exemplary embodiment of a computer system 400. The computer system 400 includes a central processing unit (CPU) 410, a memory controller (MCH) 420, a number of dual in-line memory modules (DIMMs) 425, a number of memory devices 427, a PCI Express graphic port 430, an input/output controller (ICH) 440, a number of Universal Serial Bus (USB) ports 445, an audio coder-decoder 460, a Super Input/Output (Super I/O) 450, and a firmware hub (FWH) 470.

In one embodiment, the CPU 410, the PCI Express graphic port 430, the DIMMs 425, and the ICH 440 are coupled to the MCH 420. The link 435 between the MCH 420 and the ICH 440 may include a DMI link. The MCH 420 routes data to and from the memory devices 427 via the DIMMs 425. The memory devices 427 may include various types of memories, such as, for example, dynamic random access memory (DRAM), synchronous dynamic random access memory (SDRAM), double data rate (DDR) SDRAM, or flash memory. In one embodiment, each of the DIMMs 425 is mounted on the same motherboard (not shown) via a DIMM connector (not shown) in order to couple to the MCH 420. In one embodiment, the USB ports 445, the audio coder-decoder 460, and the Super I/O 450 are coupled to the ICH 440. The Super I/O 450 may be further coupled to a firmware hub 470, a floppy disk drive 451, data input devices 453, such as, a keyboard, a mouse, etc., a number of serial ports 455, and a number of parallel ports 457.

In one embodiment, the ICH 440 includes an audio controller 442, which includes an arbiter, a number of BD DMA controllers, and a number of outbound and inbound data DMA controllers. The DMA controllers assert requests to access the memory devices 427 in response to instruction from the CPU 410. The request may include data read/write requests and BD read requests. The DMA controllers may dynamically change the attributes. The arbiter arbitrates among the requests to select a request in response to the attributes. Detail of some embodiments of the DMA controllers and the arbiter has been discussed above.

Note that any or all of the components and the associated hardware illustrated in FIG. 4 may be used in various embodiments of the computer system 400. However, it should be appreciated that other configuration of the computer system may include one or more additional devices not shown in FIG. 4. Furthermore, one should appreciate that the technique disclosed is applicable to different types of system environment, such as a multi-drop environment or a point-to-point environment. Likewise, the disclosed technique is applicable to both mobile and desktop computing systems.

The foregoing discussion merely describes some exemplary embodiments of the present invention. One skilled in the art will readily recognize from such discussion, the accompanying drawings and the claims that various modifications can be made without departing from the spirit and scope of the appended claims. The description is thus to be regarded as illustrative instead of limiting.

1. A method comprising:
dynamically modifying one or more attributes of each of a plurality of requests to access one or more memory devices; and
arbitrating among the plurality of requests to select a request to send to the one or more memory devices in a time slot based on the one or more attributes.

2. The method of claim 1, wherein dynamically modifying the one or more attributes comprises dynamically prioritizing the plurality of requests in response to latency sensitivity of each of the plurality of requests.

3. The method of claim 2, wherein the latency sensitivity of each of the plurality of requests changes in response to space available in a buffer storing the corresponding request.

4. The method of claim 1, further comprising dynamically changing a length of each of the plurality of requests in response to a size of the time slot.

5. The method of claim 1, wherein the plurality of requests comprises one or more data read requests, one or more data write requests, and one or more buffer descriptor read requests.

6. The method of claim 1, further comprising sending the selected request to the memory devices via a digital multimedia interconnect.

7. The method of claim 1, further comprising asserting the plurality of requests using a plurality of direct memory access (DMA) controllers in response to an instruction from a processor.

8. A machine-accessible medium that provides instructions that, if executed by a processor, will cause the processor to perform operations comprising:
arbitrating among a plurality of requests to access one or more memory devices to select a request to send to the one or more memory devices in a time slot based on one or more attributes of the plurality of requests; and
dynamically changing a length of each of the plurality of requests in response to a size of the time slot.

9. The machine-accessible medium of claim 8, wherein the operations further comprise dynamically prioritizing the plurality of requests in response to latency sensitivity of each of the plurality of requests.

10. The machine-accessible medium of claim 9, wherein the latency sensitivity of each of the plurality of requests changes in response to space available in a buffer storing the corresponding request.

11. The machine-accessible medium of claim 8, wherein the plurality of requests comprises one or more data read requests, one or more data write requests, and one or more buffer descriptor read requests.

12. The machine-accessible medium of claim 8, wherein the operations further comprise sending the selected request to the one or more memory devices via a digital multimedia interconnect.

13. An apparatus comprising:
a plurality of memory access controllers to assert a plurality of requests to access memory devices, wherein one or more attributes of the plurality of requests are dynamically changeable; and
a first arbiter to arbitrate among the plurality of requests to select a request based on the one or more attributes of the plurality of requests.

14. The apparatus of claim 13, wherein each of the plurality of memory access controllers further comprises a buffer to temporarily store one or more requests, a priority state machine to dynamically prioritize the one or more requests, and request length determination circuitry to determine length of the one or more requests.

15. The apparatus of claim 14, wherein the request length determination circuitry comprises a plurality of multiplexers.

16. The apparatus of claim 15, wherein the request length determination circuitry further comprises one or more flip-flops coupled to the plurality of multiplexers.

17. The apparatus of claim 13, wherein the first arbiter comprises a first plurality of arbiters and a second arbiter, outputs of the first plurality of arbiters are coupled to inputs of the second arbiter.

18. The apparatus of claim 17, wherein the first plurality of arbiters comprise a plurality of First Come First Serve (FCFS) arbiters.

19. The apparatus of claim 17, wherein the second arbiter comprises a fixed priority arbiter.

20. The apparatus of claim 14, wherein the priority state machine prioritizes the plurality of requests based on space available in the buffer of each of the plurality of memory access controllers.

21. A system comprising:
a plurality of dynamic random access memory (DRAM) devices;
one or more audio coder-decoders; and
an input/output controller, coupled between the DRAM devices and the one or more audio coder-decoders, the input/output controller having an audio controller, the audio controller comprising
a plurality of memory access controllers to assert a plurality of requests to access one or more of the DRAM devices, wherein one or more attributes of the plurality of requests are dynamically changeable; and
a first arbiter to arbitrate among the plurality of requests to select a request based on the one or more attributes of the plurality of requests.

22. The system of claim 21, wherein each of the plurality of memory access controllers further comprises a buffer to temporarily store one or more requests, a priority state machine to dynamically prioritize the one or more requests, and request length determination circuitry to determine length of the one or more requests.

23. The system of claim 22, wherein the request length determination circuitry comprises:
a plurality of multiplexers; and
one or more flip-flops coupled to the plurality of multiplexers.

24. The system of claim 21, wherein the first arbiter comprises a first plurality of arbiters and a second arbiter, outputs of the first plurality of arbiters are coupled to inputs of the second arbiter.

25. The system of claim 24, wherein the first plurality of arbiters comprise a plurality of First Come First Serve (FCFS) arbiters.

26. The system of claim 24, wherein the second arbiter comprises a fixed priority arbiter.

27. The system of claim 22, wherein the priority state machine prioritizes the plurality of requests based on space available in the buffer of each of the plurality of memory access controllers.

28. The system of claim 21, further comprising:
a memory controller coupled to the DRAM devices; and
a digital multimedia interconnect, coupled between the memory controller and the input/output controller, wherein the selected request is sent to one or more of the DRAM devices via the digital multimedia interconnect and the memory controller.

29. The system of claim 28, further comprising a central processing unit, coupled to the memory controller, to send an instruction to the input/output controller to cause the plurality of memory access controllers to assert the plurality of requests.
